(19) United States
(12) Patent Application Publication
(10) Pub. No.: US 2023/0112981 A1
(43) Pub. Date: Apr. 13, 2023

(54) ELECTROLYTE LEAKAGE DETECTION SYSTEM FOR BATTERY AND ELECTROLYTE LEAKAGE DETECTION METHOD FOR BATTERY

(71) Applicants: EBA JAPAN CO.,LTD., Tokyo (JP); TOYOTA JIDOSHA KABUSHIKI KAISHA, Toyota-shi (JP)

(72) Inventors: Naoki NORO, Tokyo (JP); Yohei TAKARA, Tokyo (JP); Kaoru OHASHI, Tokyo (JP); Yasuaki OHTSUKI, Toyota-shi (JP); Hideyuki TOKIOKA, Toyota-shi (JP); Hajime HASEGAWA, Aichi-gun (JP)

(73) Assignees: EBA JAPAN CO.,LTD., Tokyo (JP); TOYOTA JIDOSHA KABUSHIKI KAISHA, Toyota-shi (JP)

(21) Appl. No.: 17/961,776

(22) Filed: Oct. 7, 2022

(30) Foreign Application Priority Data
Oct. 11, 2021 (JP) 2021-166954

(51) Int. Cl. H01M 10/42; G01M 3/38

(52) U.S. Cl. CPC H01M 10/4228; G01M 3/38

(57) ABSTRACT

There is provide an electrolyte leakage detection system for a battery and an electrolyte leakage detection method for a battery allowing efficiently detecting an electrolyte with accuracy even when a plurality of types of batteries are mixed. An electrolyte leakage detection system for a battery includes a first irradiation unit that irradiates a first surface of a battery with a first light for determining battery data on a type of a battery, a first acquisition unit that acquires image data obtained by taking an image of the first surface of the battery irradiated with the first light, a battery data determination unit that determines the battery data based on the image data, a second irradiation unit that irradiates the first surface of the battery with a second light for detecting an electrolyte adhered to the battery corresponding to the battery data, a second acquisition unit that acquires spectral image data obtained by taking an image of the first surface of the battery irradiated with the second light, and a detection unit that detects the electrolyte based on the spectral image data.

### BACKGROUND

### 1. Technical Field

The present invention relates to an electrolyte leakage detection system for a battery and an electrolyte leakage detection method for a battery.

### 2. Related Art

In a manufacturing process of a secondary battery such as a lithium-ion battery, a battery houses an electrolyte in a battery case. When the electrolyte adheres to an outside of the battery case, corrosion or the like of the battery is concerned, and therefore, an appearance inspection for detecting the adhesion of the electrolyte is necessary. In view of this, for example, an appearance inspection method for inspecting an appearance of a lithium-ion battery as disclosed in JP-A-2020-101392 has been attracting attention.

JP-A-2020-101392 discloses an appearance inspection method for inspecting an appearance of a lithium-ion battery. In the method, a light including a near-infrared ray having a wavelength in a range of from 1381 nm to 1460 nm is irradiated on a test object that is a lithium-ion battery as an inspection target, the test object is photographed by a camera, and an electrolyte is determined to be adhered to the test object when a region of a predetermined area or more in which an optical intensity is equal to or less than a predetermined value is present based on the taken image of the test object. Accordingly, with the appearance inspection method disclosed in JP-A-2020-101392, the presence/absence of the electrolyte adhered to the outside of the lithium-ion battery can be easily determined.

On the other hand, in the process of inspecting the appearance of the battery, from the aspect of operation efficiency, it has been desired to efficiently detect the electrolyte with accuracy even when a plurality of types of batteries different in battery size and material of battery case are mixed.

However, in the appearance inspection method disclosed in JP-A-2020-101392, it is not assumed to detect the electrolytes of a plurality of types of batteries using one detector. Therefore, there is a problem that the electrolyte cannot be appropriately detected for each type of the batteries.

Accordingly, the present invention is derived to solve the above-described problem, and it is an object of the present invention to provide an electrolyte leakage detection system for a battery and an electrolyte leakage detection method for a battery allowing efficiently detecting an electrolyte with accuracy even when a plurality of types of batteries are mixed.

### SUMMARY

An electrolyte leakage detection system for a battery according to a first invention includes a first irradiation unit, a first acquisition unit, a battery data determination unit, a second irradiation unit, a second acquisition unit, and a detection unit. The first irradiation unit irradiates a first surface of a battery with a first light. The first light is for determining battery data on a type of the battery. The first acquisition unit acquires image data obtained by taking an image of the first surface of the battery irradiated with the first light by the first irradiation unit. The battery data determination unit determines the battery data based on the image data acquired by the first acquisition unit. The second irradiation unit irradiates the first surface of the battery with a second light corresponding to the battery data determined by the battery data determination unit. The second light is for detecting an electrolyte adhered to the battery. The second acquisition unit acquires spectral image data obtained by taking an image of the first surface of the battery irradiated with the second light by the second irradiation unit. The detection unit that detects the electrolyte based on the spectral image data acquired by the second acquisition unit.

In an electrolyte leakage detection system for a battery according to a second invention, which is in the first invention, the battery data determination unit extracts area data indicating an area in which an intensity of the first light becomes equal to or more than a threshold value from the image data acquired by the first acquisition unit, and determines the battery data based on the area data.

In an electrolyte leakage detection system for a battery according to a third invention, which is in the first invention or the second invention, the second irradiation unit includes two or more lighting devices having mutually different angles of irradiating the first surface of the battery with the second light for detecting the electrolyte adhered to the battery, selects a lighting device that emits the second light from the two or more lighting devices corresponding to the battery data determined by the battery data determination unit, and irradiates the first surface of the battery with the second light using the lighting device.

In an electrolyte leakage detection system for a battery according to a fourth invention, which is in any of the first invention to the third invention, the second irradiation unit designates a wavelength of the second light corresponding to the battery data determined by the battery data determination unit.

In an electrolyte leakage detection system for a battery according to a fifth invention, which is in any of the first invention to the fourth invention, the second acquisition unit acquires any of the spectral image data including the second light reflected by the first surface of the battery, the spectral image data including the second light scattered by the first surface of the battery, and the spectral image data including a light of the electrolyte fluoresced by the second light corresponding to the battery data determined by the battery data determination unit.

In an electrolyte leakage detection system for a battery according to a sixth invention, which is in any of the first invention to the fifth invention, the detection unit selects a specific wavelength in a predetermined wavelength range as a normalization wavelength and a specific wavelength in a predetermined wavelength range as an evaluation wavelength based on the spectral image data acquired by the second acquisition unit, calculates a reflectance from a difference of a spectral intensity between the normalization wavelength and the evaluation wavelength in a wavelength range between the normalization wavelength and the evaluation wavelength, and detects the electrolyte based on the calculated reflectance.

An electrolyte leakage detection method for a battery according to a seventh invention includes: a first irradiation step of irradiating a first surface of a battery with a first light, the first light being for determining battery data on a type of the battery; a first acquisition step of acquiring image data obtained by taking an image of the first surface of the battery irradiated with the first light by the first irradiation step; a battery data determination step of determining the battery data based on the image data acquired by the first acquisition step; a second irradiation step of irradiating the first surface of the battery with a second light corresponding to the battery data determined by the battery data determination step, the second light being for detecting an electrolyte adhered to the battery; a second acquisition step of acquiring spectral image data obtained by taking an image of the first surface of the battery irradiated with the second light by the second irradiation step; and a detection step of detecting the electrolyte based on the spectral image data acquired by the second acquisition step.

According to the first invention to the sixth invention, the electrolyte leakage detection system for a battery irradiates the first surface of the battery with the second light corresponding to the battery data. This allows acquiring the spectral image data using the emission method appropriate for each of the battery types. Accordingly, even when a plurality of types of batteries are mixed, the electrolyte can be efficiently detected with accuracy.

Especially, according to the second invention, the battery data determination unit extracts the area data from the image data, and determines the battery data based on the area data. This allows determining the size of the first surface of the battery from the image data. Accordingly, even when a plurality of types of batteries are mixed, the electrolyte can be efficiently detected with accuracy.

Especially, according to the third invention, the second irradiation unit selects a lighting device that emits the second light from two or more lighting devices corresponding to the battery data, and irradiates the first surface of the battery with the second light using the lighting device. This allows emitting the second light using the lighting device appropriate for each of the battery types. Accordingly, even when a plurality of types of batteries are mixed, the electrolyte can be efficiently detected with accuracy.

Especially, according to the fourth invention, the wavelength of the second light is designated corresponding to the battery data. This allows detecting the electrolyte using the second light having the wavelength appropriate for each of the battery types. Accordingly, even when a plurality of types of batteries are mixed, the electrolyte can be efficiently detected with more accuracy.

Especially, according to the fifth invention, the second acquisition unit acquires any of the spectral image data including the second light reflected by the first surface of the battery, the spectral image data including the second light scattered by the first surface of the battery, and the spectral image data including a light of the electrolyte fluoresced by the second light corresponding to the battery data. Accordingly, even when a plurality of types of batteries are mixed, the electrolyte can be efficiently detected with more accuracy. Therefore, for example, also in a case where the battery data indicates a battery including a metal battery case, the spectral image data including the second light specularly reflected by the first surface of the battery can be acquired. Accordingly, even when a battery including a metal battery case is mixed, the electrolyte can be efficiently detected with more accuracy. Additionally, for example, also in a case where the battery data indicates a battery including a battery case laminated with aluminum, and unevenness is present on the surface of the battery case, the spectral image data including the second light scattered by the first surface of the battery or the spectral image data including a light of the electrolyte fluoresced by the second light can be acquired. Accordingly, even when a battery including a battery case laminated with aluminum is mixed, the electrolyte can be efficiently detected with more accuracy.

Especially, according to the sixth invention, the detection unit calculates a reflectance from a difference of a spectral intensity between the normalization wavelength and the evaluation wavelength, and detects the electrolyte based on the calculated reflectance. This allows separating the features of the taken spectral image data. Accordingly, the electrolyte can be efficiently detected with more accuracy.

According to the seventh invention, the electrolyte leakage detection method for a battery irradiates the first surface of the battery with the second light corresponding to the battery data. This allows acquiring the spectral image data using the emission method appropriate for each of the battery types. Accordingly, even when a plurality of types of batteries are mixed, the electrolyte can be efficiently detected with accuracy.

### BRIEF DESCRIPTION OF THE DRAWINGS

FIG. 1 is a schematic diagram illustrating an exemplary configuration of an electrolyte leakage detection system according to the embodiment;

FIG. 2A is a schematic diagram illustrating an exemplary configuration of an electrolyte leakage detection device according to the embodiment;

FIG. 2B is a schematic diagram illustrating exemplary functions of the electrolyte leakage detection device according to the embodiment;

FIG. 3 is a schematic diagram illustrating an exemplary battery according to the embodiment;

FIG. 4 is a diagram illustrating an exemplary flowchart of an operation of the electrolyte leakage detection system according to the embodiment;

FIG. 5 is a schematic diagram illustrating an example of a ring-shaped white LED lighting device according to the embodiment;

FIG. 6A is a diagram illustrating an example of spectral image data obtained by taking an image of a second light reflected by a first surface of the battery according to the embodiment; and

FIG. 6B is a diagram illustrating an example of spectral image data obtained by taking an image of the second light scattered by the first surface of the battery according to the embodiment.

### DETAILED DESCRIPTION

The following describes examples of an electrolyte leakage detection system for a battery and an electrolyte leakage detection method for a battery in embodiments to which the present invention is applied by referring to the drawings.

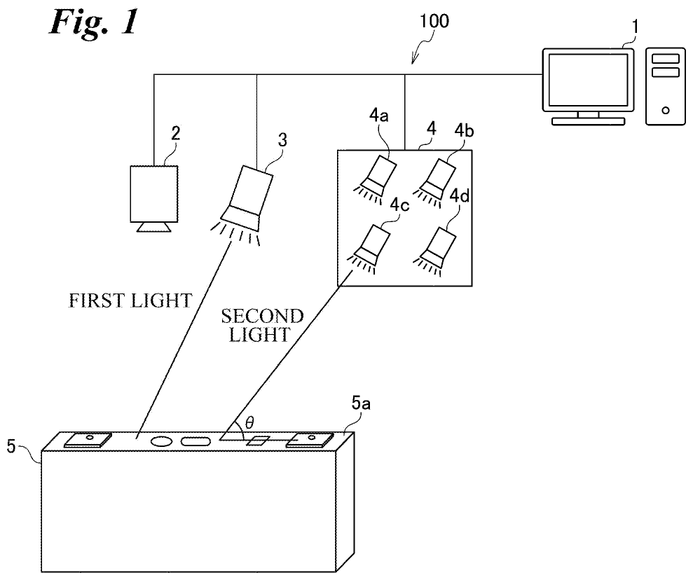

FIG. 1 is a schematic diagram illustrating an exemplary configuration of an electrolyte leakage detection system 100. For example, as illustrated in FIG. 1, the electrolyte leakage detection system 100 includes an electrolyte leakage detection device 1, and an imaging device 2, a first lighting unit 3, and a second lighting unit 4, which are connected to the electrolyte leakage detection device 1. The electrolyte leakage detection system 100 detects an electrolyte adhered to a first surface 5a of a battery 5. The imaging device 2, the first lighting unit 3, and the second lighting unit 4 may be provided in, for example, a dark room.

The first lighting unit 3 is a lighting device that irradiates the first surface 5a of the battery 5 with a first light for determining battery data on the type of the battery 5. The first lighting unit 3 may be a lighting device having any light source such as a halogen lamp, a Light Emitting Diode (LED), and a fluorescent lamp.

While the first lighting unit 3 may emit the first light, for example, having a wavelength of 580 nm, it is not limited to this, and the first lighting unit 3 may emit the first light having any wavelength.

The imaging device 2 is a known camera that takes an image of the battery 5 and generates image data and spectral image data. As the imaging device 2, for example, an RGB camera, a multispectral camera, a target spectral camera, and a hyperspectral camera may be used. The imaging device 2 may be, for example, a video camera that shoots a video, and may be included in the electrolyte leakage detection device 1. When the imaging device 2 is a spectral video camera, for example, the spectral image data may be extracted from a part of the shot video.

The imaging device 2 outputs the taken image data and spectral image data to the electrolyte leakage detection device 1. The imaging device 2 outputs, for example, the image data obtained by taking an image of the first surface 5a of the battery 5 irradiated with the first light to the electrolyte leakage detection device 1. The imaging device 2 outputs, for example, the spectral image data obtained by taking an image of the first surface 5a of the battery 5 irradiated with the second light for detecting the electrolyte to the electrolyte leakage detection device 1.

The electrolyte leakage detection device 1 performs respective processes based on the image data and the spectral image data output from the imaging device 2. As the electrolyte leakage detection device 1, for example, in addition to electronic equipment such as a personal computer (PC), electronic equipment such as a smart phone, a tablet terminal, a wearable device, and an Internet of Things (IoT) device and a single board computer such as Raspberry Pi (registered trademark) may be used. For example, the electrolyte leakage detection device 1 may include the imaging device 2.

For example, the electrolyte leakage detection device 1 extracts area data indicating an area in which an intensity of the first light becomes equal to or more than a threshold value from the image data obtained by taking an image of the first surface 5a of the battery 5 irradiated with the first light output from the imaging device 2, and determines the battery data based on the area data. The electrolyte leakage detection device 1 outputs an instruction of emitting the second light to the second lighting unit 4 corresponding to the determined battery data. For example, the electrolyte leakage detection device 1 detects the electrolyte based on the spectral image data obtained by taking an image of the first surface 5a of the battery 5 irradiated with the second light output from the imaging device 2.

The second lighting unit 4 irradiates the first surface 5a of the battery 5 with the second light for detecting the electrolyte in response to the instruction output by the electrolyte leakage detection device 1. For example, the second lighting unit 4 includes a plurality of lighting devices 4a to 4d having mutually different angles θ of irradiating the first surface 5a of the battery 5 with the second light. For example, the second lighting unit 4 may include the plurality of lighting devices 4a to 4d having mutually different wavelengths of the second light to be emitted. In this case, the second lighting unit 4 may irradiate the first surface 5a of the battery 5 with the second light using any of the lighting devices 4a to 4d corresponding to the instruction output from the electrolyte leakage detection device 1 among the plurality of lighting devices 4a to 4d.

For example, while the second lighting unit 4 may emit the second light using a lighting device of the first lighting unit 3 emitting the first light, it is not limited to this, and the second lighting unit 4 may emit a light having any wavelength as the second light. The second lighting unit 4 may emit, for example, a light having the wavelength of 365 nm as the second light.

In the second lighting unit 4, for example, the angle θ of irradiating the first surface 5a of the battery 5 with the second light may be operated in response to the instruction output from the electrolyte leakage detection device 1. In the second lighting unit 4, for example, the wavelength of the second light to be emitted may be operated in response to the instruction output from the electrolyte leakage detection device 1.

The second lighting unit 4 includes a plurality of any light sources such as a halogen lamp, an LED, and a fluorescent lamp. The second lighting unit 4 may include the first lighting unit 3. As the second lighting unit 4, a ring-shaped lighting device may be used.

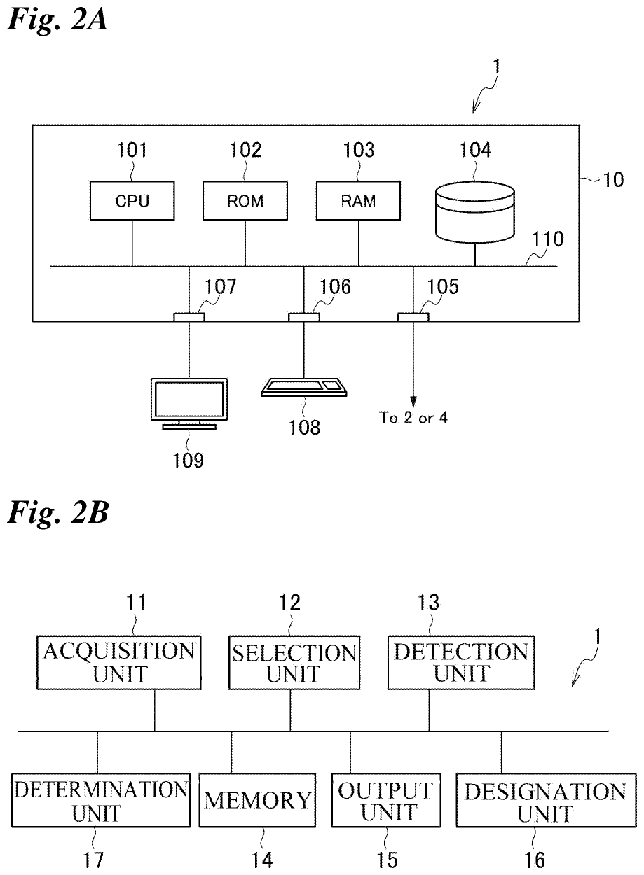

Next, an example of the electrolyte leakage detection device 1 according to the embodiment will be described with reference to FIGS. 2A and 2B. FIG. 2A is a schematic diagram illustrating an exemplary configuration the electrolyte leakage detection device 1 according to the embodiment. FIG. 2B is a schematic diagram illustrating exemplary functions of the electrolyte leakage detection device 1 according to the embodiment.

For example, as illustrated in FIG. 2A, the electrolyte leakage detection device 1 includes a housing 10, a Central Processing Unit (CPU) 101, a Read Only Memory (ROM) 102, a Random Access Memory (RAM) 103, a storage unit 104, and I/Fs 105 to 107. The CPU 101, the ROM 102, the RAM 103, the storage unit 104, and the I/Fs 105 to 107 are mutually connected by an internal bus 110.

The CPU 101 controls the entire electrolyte leakage detection device 1. The ROM 102 stores operation codes of the CPU 101. The RAM 103 is a work area used in the operation of the CPU 101. The storage unit 104 stores various kinds of information such as the battery data, the image data, and the spectral image data. For the storage unit 104, for example, a data storage device such as a Solid State Drive (SSD), an SD card, and a mini SD card is used in addition to a Hard Disk Drive (HDD). For example, the electrolyte leakage detection device 1 may include a Graphics Processing Unit (GPU) (not illustrated).

The I/F 105 is an interface for transmitting and receiving the various kinds of information with the imaging device 2 or the second lighting unit 4. The I/F 106 is an interface for transmitting and receiving information with an input unit 108. For the input unit 108, for example, a keyboard is used, and a detector or the like using the electrolyte leakage detection device 1 inputs the various kinds of information, a control command of the electrolyte leakage detection device 1, or the like via the input unit 108. The I/F 107 is an interface for transmitting and receiving the various kinds of information with a display unit 109. The display unit 109 outputs various kinds of information such as a detection result stored in the storage unit 104, or a processing state and the like of the electrolyte leakage detection device 1. A display is used as the display unit 109, and for example, a touch panel display may be employed.

The storage unit 104 stores, for example, the image data and the spectral image data acquired from the imaging device 2, and additionally, stores information regarding the spectral image data and the like, an algorithm used for detecting the electrolyte, and the like.

The display unit 109 displays the various kinds of information. The display unit 109 displays, for example, the detection result, the battery data, and the like.

FIG. 2B is a schematic diagram illustrating exemplary functions of the electrolyte leakage detection device 1. The electrolyte leakage detection device 1 includes an acquisition unit 11, a selection unit 12, a detection unit 13, a memory 14, an output unit 15, a designation unit 16, and a determination unit 17. The acquisition unit 11, the selection unit 12, the detection unit 13, the memory 14, the output unit 15, the designation unit 16, and the determination unit 17 illustrated in FIG. 2B are achieved by executing a program stored in the storage unit 104 or the like using the RAM 103 as the work area by the CPU 101, and for example, may be controlled by an artificial intelligence.

The acquisition unit 11 acquires the image data and the spectral image data obtained by taking an image of the battery 5. The acquisition unit 11 acquires the image data and the spectral image data from the imaging device 2 or the like, and additionally, for example, may be configured to acquire the image data and the spectral image data from the imaging device 2 included in the electrolyte leakage detection device 1. A frequency and a cycle of acquiring the various kinds of information by the acquisition unit 11 are appropriately set.

The determination unit 17 determines the battery data based on the image data acquired by the acquisition unit 11. For example, the determination unit 17 extracts the area data indicating the area in which the intensity of the first light becomes equal to or more than the threshold value from the image data acquired by the acquisition unit 11, and determines the battery data based on the area data.

The designation unit 16 causes the second lighting unit 4 to emit the second light corresponding to the battery data determined by the determination unit 17. The designation unit 16 designates any of the lighting devices 4a to 4d that irradiates the first surface 5a of the battery 5 with the second light among the lighting devices 4a to 4d included in the second lighting unit 4 corresponding to the battery data determined by the determination unit 17. The designation unit 16 also designates the wavelength of the second light. The designation unit 16 outputs an instruction to cause the designated lighting devices 4a to 4d to emit the second light having the designated wavelengths to the second lighting unit 4.

The selection unit 12 selects a specific wavelength in a predetermined wavelength range as a normalization wavelength and selects a specific wavelength in a predetermined wavelength range as an evaluation wavelength, based on the spectral image data acquired by the acquisition unit 11 for reducing influences of conditions, such as unevenness of light and a shadow, for example, even when the conditions are different. The normalization wavelength is a wavelength as a target of a normalization for detecting the electrolyte. The evaluation wavelength is a wavelength for an evaluation to normalize the normalization wavelength. For example, the selection unit 12 may select the wavelength ranges of the normalization wavelength and the evaluation wavelength corresponding to the battery data.

The detection unit 13 calculates a reflectance from a difference of a spectral intensity between the normalization wavelength and the evaluation wavelength in a wavelength range between the normalization wavelength and the evaluation wavelength selected by the selection unit 12, and detects the electrolyte of the battery 5 based on the calculated reflectance.

For example, the detection unit 13 provides an adhesion level indicating an adhesion amount of the electrolyte from pixel distributions of respective portions of the battery 5 based on the detection result of the spectral image data.

The memory 14 retrieves various kinds of information stored in the storage unit 104 as necessary. The memory 14 stores various kinds of information acquired or output by the acquisition unit 11, the selection unit 12, the detection unit 13, the designation unit 16, and the determination unit 17 in the storage unit 104.

The output unit 15 outputs the various kinds of information. The output unit 15 transmits an instruction to the second lighting unit 4 via the I/F 105. The output unit 15 transmits the detection result to the display unit 109 via the I/F 107.

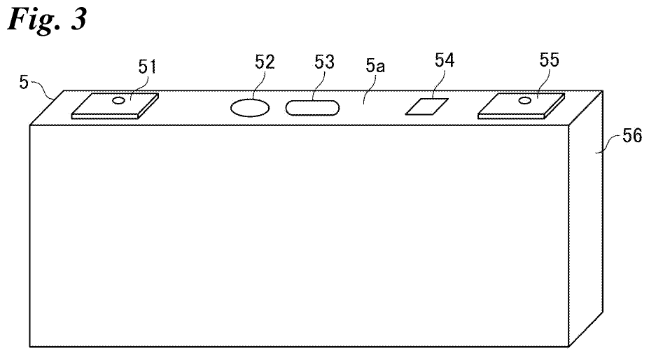

While the battery 5 is, for example, a lithium ion secondary battery, it is not limited to this, and may be any battery. As illustrated in FIG. 3, the battery 5 includes a battery case 56.

The battery case 56 is a metallic container formed of aluminum, an aluminum alloy, or the like. The battery case 56 may be laminated with, for example, aluminum. An electrolyte is sealed in the battery case 56. For example, an electrolyte in which lithium salt such as lithium hexafluorophosphate (LiPF₆) is contained in an organic solvent containing ethylene carbonate or the like is sealed in the battery case 56.

The battery case 56 includes the first surface 5a.

While the first surface 5a may be one surface of the battery case 56 including, for example, a positive electrode terminal 51, a liquid injection portion 52, a safety valve 53, a thermistor connecting portion 54, and a negative electrode terminal 55, it is not limited to this, and the first surface 5a may be any one surface of the battery case 56.

The positive electrode terminal 51 is a terminal of a positive electrode. The positive electrode terminal 51 is a metal portion of the positive electrode formed of, for example, aluminum.

The negative electrode terminal 55 is a terminal of a negative electrode. The negative electrode terminal 55 is a metal portion of the negative electrode formed of, for example, copper.

The positive electrode terminal 51 and the negative electrode terminal 55 are those, for example, in which a positive electrode plate including a positive electrode active material layer formed on a strip-shaped aluminum foil and a negative electrode plate including a negative electrode active material layer formed on a strip-shaped copper foil are laminated via a separator and flatly wound. The positive electrode terminal 51 and the negative electrode terminal 55 are respectively connected to the negative electrode plate and the positive electrode plate in the battery case 56.

The thermistor connecting portion 54 is a portion to which a thermistor that detects the temperature change such as an abnormal heat generation due to overcharge is connected. The thermistor connecting portion 54 may be connected to, for example, a Positive Temperature Coefficient (PTC) thermistor. The thermistor connecting portion 54 may be a metal portion formed of aluminum, an aluminum alloy, or the like.

The liquid injection portion 52 is an inlet for injecting the electrolyte.

The safety valve 53 is a valve for discharging a gas or the like inside the battery case 56.

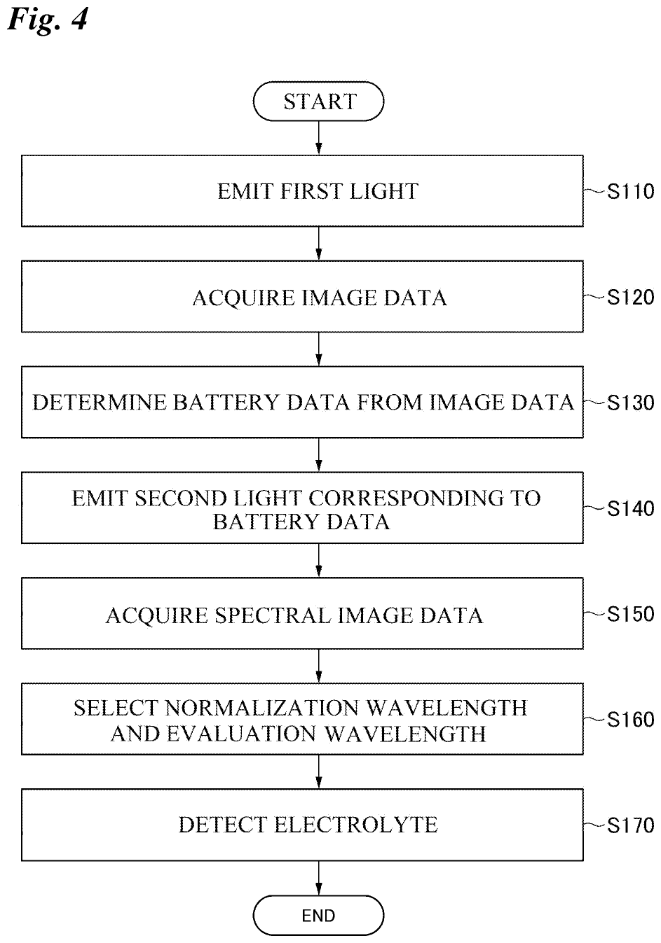

Next, an exemplary operation of the electrolyte leakage detection system 100 according to the embodiment will be described. FIG. 4 is a flowchart illustrating an exemplary operation of the electrolyte leakage detection system 100 according to the embodiment.

First, in a first irradiation step S110, the first lighting unit 3 irradiates the first surface 5a of the battery 5 with the first light. The first lighting unit 3 emits, for example, a light having a wavelength of 580 nm as the first light. The first light emitted in the first irradiation step S110 is reflected by the first surface 5a of the battery 5.

Next, in a first acquisition step S120, the acquisition unit 11 acquires image data obtained by taking an image of the first surface 5a of the battery 5 irradiated with the first light by the first lighting unit 3. The acquisition unit 11 acquires the image data including the first surface 5a of the battery 5 reflecting the first light emitted in the first irradiation step S110. The acquisition unit 11 may acquire the image data of the first surface 5a of the battery 5 taken by the imaging device 2 via the I/F 105. The acquisition unit 11 stores the image data in the storage unit 104, for example, via the memory 14.

Next, in a determination step S130, the determination unit 17 determines battery data from the image data acquired by the acquisition unit 11.

The battery data is data on the type of the battery 5. For example, the battery data is data indicating the model number of the battery 5. For example, the battery data may be data indicating that the battery 5 is a lithium-ion battery. For example, the battery data may be data indicating that the battery 5 includes the battery case 56 that is a metallic container formed of aluminum, an aluminum alloy, or the like. For example, the battery data may be data indicating that the battery 5 includes the battery case 56 laminated with aluminum. For example, the battery data includes data on the material of the battery case 56 of the battery 5.

For example, in the first acquisition step S120, the determination unit 17 may extract area data indicating an area in which an intensity of the first light emitted in the first irradiation step S110 becomes equal to or more than a threshold value from the acquired image data, and determine the battery data based on the area data. In this case, the image data indicates an image reflecting the intensity of the first light reflected by the first surface 5a of the battery 5. The determination unit 17 extracts the area from this image based on the number of pixels at which the intensity of the first light is the threshold value or more, and generates the area data based on the area. Accordingly, the size of the battery 5 can be determined from the image data.

Next, for example, the determination unit 17 may refer to a correspondence table, which is preliminarily stored in the memory 14, between the area data and the battery data, and acquire the battery data corresponding to the extracted area data. In this case, as illustrated in Table 1, a correspondence table between the area data and the battery data may be used with a proportion of the number of pixels at which the intensity of the first light becomes equal to or more than the threshold value in the number of pixels of the whole image data as the area data. Accordingly, the battery data can be determined from the size of the battery 5.

TABLE 1

| Area Data | Battery Data |
|---|---|
| 0 to 25% | Battery Data A |
| 26 to 50% | Battery Data B |
| 51% to 75% | Battery Data C |
| 76% to 100% | Battery Data D |

In the determination step S130, for example, the determination unit 17 may determine the battery data from the image data acquired by the acquisition unit 11 using a known image recognition. In this case, the determination unit 17 may calculate a degree of similarity between image data that is preliminarily stored in the memory 14 and associated with each piece of the battery data and the image data acquired by the acquisition unit 11, and determine the battery data corresponding to the calculated degree of similarity.

Next, in a second irradiation step S140, the second lighting unit 4 irradiates the first surface 5a of the battery 5 with the second light corresponding to the battery data determined in the determination step S130. For example, the designation unit 16 may designate any of the lighting devices 4a to 4d that emit the second light among the plurality of lighting devices 4a to 4d included in the second lighting unit 4 corresponding to the battery data determined in the determination step S130, and cause the second lighting unit 4 to emit the second light using the designated lighting devices 4a to 4d. In this case, as illustrated in Table 2, the designation unit 16 may refer to a correspondence table, which is preliminarily stored in the memory 14, between the battery data and the emission method of the second light, select an emission method corresponding to the determined battery data, and designate any of the lighting devices 4a to 4d that emits the second light based on the emission method. The emission method includes information on the lighting devices 4a to 4d caused to emit the second light, an angle of emitting the second light, the wavelength of the second light, and the like. Accordingly, the electrolyte can be detected using the irradiation angle appropriate for each type of the battery 5.

TABLE 2

| Battery Data | Emission Method |
|---|---|
| Battery Data A | Emission Method A |
| Battery Data B | Emission Method B |
| Battery Data C | Emission Method C |
| Battery Data D | Emission Method D |

In the second irradiation step S140, the designation unit 16 may designate the angle of irradiating the first surface 5a of the battery 5 with the second light by the second lighting unit 4 corresponding to the battery data determined in the determination step S130, and operate the second lighting unit 4 so as to emit the second light with the designated angle.

The designation unit 16 may designate the wavelength of the second light corresponding to the battery data determined in the determination step S130, and cause the second lighting unit 4 to emit a light having the designated wavelength as the second light. The designation unit 16 may cause the second lighting unit 4 to emit an infrared light or an ultraviolet light.

Next, in a second acquisition step S150, the imaging device 2 takes an image including the first surface 5a of the battery 5 irradiated with the second light to obtain spectral image data, and the acquisition unit 11 acquires the spectral image data taken by the imaging device 2. In the second irradiation step S140, features of the spectral image data taken by the imaging device 2 are different for each of the lighting devices 4a to 4d of the second lighting unit 4 that emitted the second light. For example, when the battery data determined in the determination step S130 indicates the battery 5 including the metal battery case 56, the imaging device 2 may acquire the spectral image data including the second light reflected by the first surface 5a of the battery 5. In this case, in the second irradiation step S140, the designation unit 16 may use the lighting devices 4a to 4d configured such that the second light emitted by the second lighting unit 4 is specularly reflected by the first surface 5a of the battery 5 and the specularly reflected second light is irradiated on the imaging device 2. The designation unit 16 may cause the first lighting unit 3 to irradiate the first surface 5a of the battery 5 with the second light. Therefore, for example, also in the case where the battery data indicates the battery 5 including the metal battery case 56, the spectral image data including the second light specularly reflected by the first surface 5a of the battery 5 can be acquired.

In the second acquisition step S150, for example, when the battery data determined in the determination step S130 indicates the battery 5 including the battery case 56 laminated with aluminum, the imaging device 2 may acquire the spectral image data including the second light scattered by the first surface 5a of the battery 5. In this case, in the second irradiation step S140, the designation unit 16 may use the lighting devices 4a to 4d configured such that the second light emitted by the second lighting unit 4 is scattered by the first surface 5a of the battery 5 and the scattered second light is irradiated on the imaging device 2. In this case, the second light scattered by the first surface 5a of the battery 5 includes the second light diffusely reflected by the first surface 5a of the battery 5.

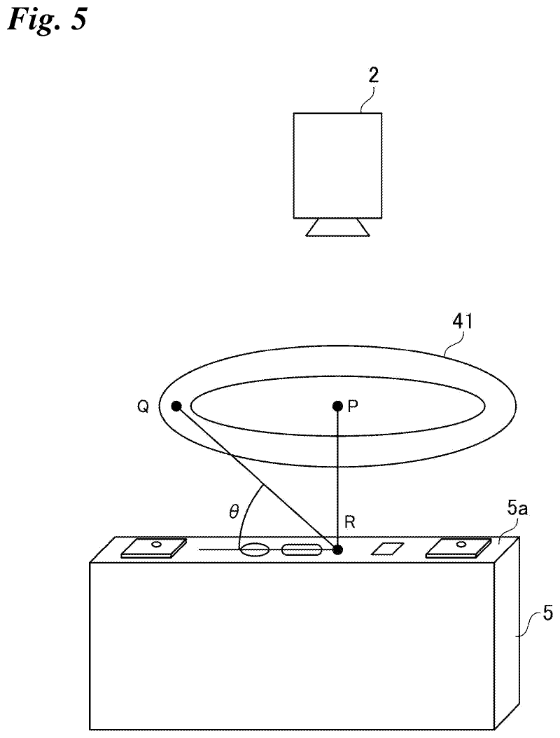

Additionally, in this case, the designation unit 16 may cause a ring-shaped white LED lighting device 41 as illustrated in FIG. 5 to emit the second light. At this time, an angle θ of emitting the second light of the ring-shaped white LED lighting device 41 is an angle of the first surface 5a relative to a straight line passing through an intersection point R and a center point Q. The intersection point R is an intersection point of a perpendicular line of the ring-shaped white LED lighting device 41 passing through a center point P of an inner circumference of the ring-shaped white LED lighting device 41 and the first surface 5a. The center point Q is any center point between the inner circumference and an outer circumference of the ring-shaped white LED lighting device 41. Accordingly, for example, also in the case where the battery data indicates the battery 5 including the battery case 56 laminated with aluminum, the spectral image data including the second light scattered by the first surface 5a of the battery 5 can be acquired. Using the lighting device allowing an oblique illumination of the second light like the ring-shaped white LED lighting device 41 allows a dark-field illumination, thus allowing more emphasizing the contrast of the battery 5. Accordingly, even when unevenness is present on the surface of the battery 5, the electrolyte can be detected with high accuracy.

In the second acquisition step S150, for example, when the battery data determined in the determination step S130 indicates the battery including the battery case laminated with aluminum, the imaging device 2 may acquire the spectral image data including a light of the electrolyte fluoresced by the second light. In this case, in the second irradiation step S140, the designation unit 16 may use the lighting devices 4a to 4d configured such that the electrolyte adhered to the first surface 5a of the battery 5 is fluoresced by the second light emitted by the second lighting unit 4 and the fluorescent light of the electrolyte is irradiated on the imaging device 2. In this case, for example, the designation unit 16 may cause the second lighting unit 4 to emit a light having a wavelength in an infrared range or an ultraviolet range as the second light. Therefore, for example, also in a case where the battery data indicates the battery 5 including the battery case laminated with aluminum, the spectral image data including the light of the electrolyte fluoresced by the second light can be acquired. Accordingly, even when unevenness is present on the surface of the battery 5, the electrolyte can be detected with high accuracy.

Next, in a selection step S160, the selection unit 12 selects a normalization wavelength and an evaluation wavelength included in wavelength ranges of a spectral graph based on the acquired spectral image data.

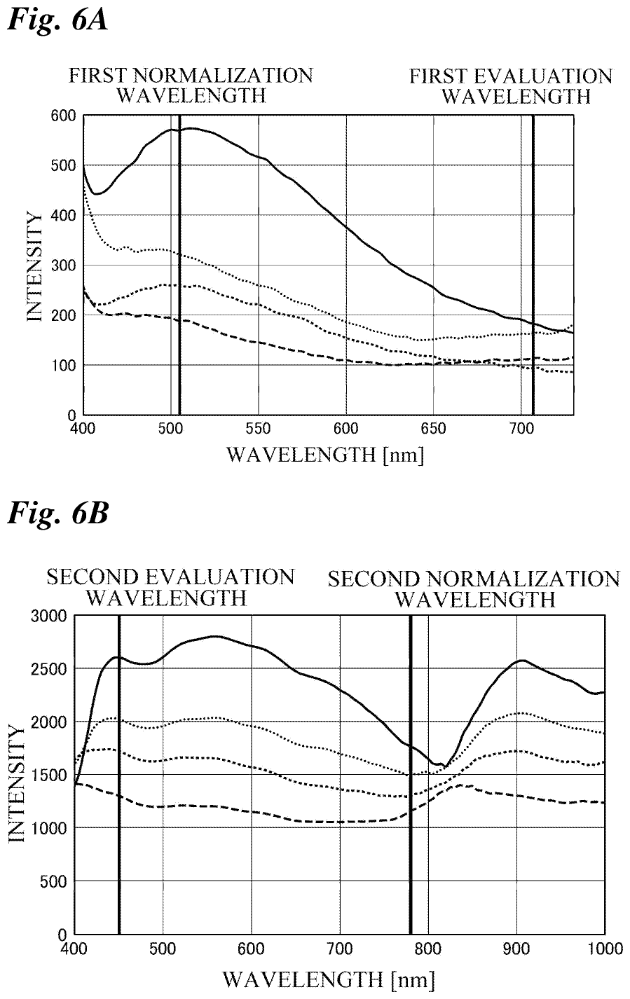

FIG. 6A and FIG. 6B each illustrate a plurality of spectral graphs indicated by the spectral image data at a plurality of positions of the first surface 5a of the battery 5 taken by the imaging device 2. FIG. 6A and FIG. 6B are graphs each having a vertical axis indicating the intensity of the light and the horizontal axis indicating the wavelength [nm]. Solid lines and dashed lines of the plurality of spectral graphs correspond to, for example, the respective spectra of the second light taken at the plurality of positions of the first surface 5a of the battery 5.

FIG. 6A is a graph illustrating the spectra obtained by emitting the second light using a UV-LED light as the second lighting unit 4 in the second irradiation step S140 and taking an image of the second light reflected by the first surface 5a of the battery 5 in the second acquisition step S150. FIG. 6B is a graph illustrating the spectra obtained by emitting the second light using the ring-shaped white LED lighting device 41 as the second lighting unit 4 in the second irradiation step S140 and taking an image of the second light scattered by the first surface 5a of the battery 5 in the second acquisition step S150.

The selection unit 12 selects specific wavelengths that are the wavelengths included in these spectral graphs as a normalization wavelength and an evaluation wavelength. The selection unit 12 may set the wavelengths at which difference values of the spectral intensity between the respective spectral graphs become the largest as the specific wavelengths. The selection unit 12 may specify singular points at which convex peaks of the respective spectral graphs are formed as the specific wavelengths. The selection unit 12 may select the specific wavelength by an analysis using a learned model using a regression analysis, a brute-force analysis, a machine learning, or the like.

For example, based on the difference in wavelength between the respective spectral graphs illustrated in FIG. 6A, the selection unit 12 selects 520 nm at which the difference is large as the first normalization wavelength, and 710 nm at which the difference is small as the first evaluation wavelength. For example, based on the difference in wavelength between the respective spectral graphs illustrated in FIG. 6B, the selection unit 12 selects 450 nm at which the difference is large as the second normalization wavelength, and 785 nm at which the difference is small as the second evaluation wavelength.

Here, for example, the normalization wavelength and the evaluation wavelength may be specified at one point, and may be specified at a plurality of points. Alternatively, the wavelength ranges including the normalization wavelength and the evaluation wavelength at the centers may be set. The wavelength ranges may be configured as preliminarily set predetermined wavelength ranges such as wavelength widths in which the respective differences of the normalization wavelength and the evaluation wavelength become ±10 nm. Therefore, provisionally, when the normalization wavelength is 550 nm and the wavelength range is ±10 nm, the range in which the spectral data is actually detected is from 540 nm to 560 nm. In this case, as a way to designate the normalization wavelength and the evaluation wavelength, for example, the wavelengths at the centers of the respective wavelength ranges may be used as the specific wavelengths.

For example, the selection unit 12 may refer to a database that is preliminarily stored in the storage unit 104 and includes the normalization wavelengths and the evaluation wavelengths associated with the battery data, and select the normalization wavelength and the evaluation wavelength associated with the battery data determined in the determination step S130.

The database stores the normalization wavelengths and the evaluation wavelengths associated with respective pieces of the battery data. Furthermore, the other specific wavelengths, the ranges of the specific wavelengths, and arithmetic methods and arithmetic expressions that define them in some cases may be stored in association with the respective pieces of the battery data.

The selection unit 12 may refer to the database corresponding to the battery data determined in the determination step S130, and select a specific wavelength included in a predetermined wavelength range as the normalization wavelength and a specific wavelength included in a predetermined wavelength range as the evaluation wavelength.

When the battery data indicates the battery 5 including the metal battery case 56, the selection unit 12 may select, for example, the specific wavelength included in the wavelength range of from 620 nm to 780 nm as the normalization wavelength, and for example, the specific wavelength included in the wavelength range of from 450 nm to 550 nm as the evaluation wavelength.

When the battery data indicates the battery 5 including the metal battery case 56, the selection unit 12 may select, for example, the specific wavelength included in the wavelength range of from 780 nm to 1000 nm as the normalization wavelength, and for example, the specific wavelength included in the wavelength range of from 450 nm to 550 nm as the evaluation wavelength.

When the battery data indicates the battery 5 including the battery case 56 laminated with aluminum, the selection unit 12 may select, for example, the specific wavelength included in the wavelength range of from 400 nm to 500 nm as the normalization wavelength, and for example, the specific wavelength included in the wavelength range of from 500 nm to 600 nm as the evaluation wavelength. Accordingly, the features of the spectral image data can be separated corresponding to the battery data.

Next, in a detection step S170, the detection unit 13 calculates a reflectance from a difference of the spectral intensity between the normalization wavelength and the evaluation wavelength in a wavelength range between the normalization wavelength and the evaluation wavelength selected by the selection unit 12, thus detecting the electrolyte of the battery 5.

For example, the detection unit 13 calculates an adhesion level indicating an adhesion amount of the electrolyte from a spectral change based on the difference of the spectral intensity between the normalization wavelength and the evaluation wavelength. In this case, by a normalization with a sum of the spectral intensities of the normalization wavelength and the evaluation wavelength, even when the conditions, such as unevenness of light and a shadow, are different, the adhesion levels can be compared while reducing the influence of them. The calculation of the adhesion level can be performed by, for example, known spectrum measurement method, spectrum analysis technique (for example, “NDSI: normalized difference spectral index”), or the like using a formula below. For example, “Iλ” is a reflectance of “λₙₘ”, and obtained with the normalization wavelength as “λ2” and the evaluation wavelength as “λ1”.

$$NDSI = \frac{{I}_{λ 1} - {I}_{λ 2}}{{I}_{λ 1} + {I}_{λ 2}} \qquad [ Math . 1 ]$$

In the detection step S170, for example, the detection unit 13 provides an adhesion level indicating an adhesion amount of the electrolyte from pixel distributions of respective portions such as the positive electrode terminal 51 or the negative electrode terminal 55 of the battery 5 based on the detection result of the spectral image data. As the adhesion level, for example, a specific degree of adhesion such as levels 1 to 5 may be indicated corresponding to the electrolyte amount per area.

The detection unit 13 generates the detection result using, for example, format data such as an output format stored in the storage unit 104. The detection unit 13 stores the detection result in the storage unit 104 via, for example, the memory 14.

Next, the output unit 15 outputs the detection result. The output unit 15 outputs the detection result to the display unit 109 or the like.

Thus, the operation of the electrolyte leakage detection device 1 according to the embodiment ends. Accordingly, even when a plurality of types of batteries are mixed, the electrolyte can be efficiently detected with accuracy.

While the embodiments of the present invention have been described, the embodiments have been presented as examples, and are not intended to limit the scope of the invention. The novel embodiments described herein can be embodied in a variety of other configurations. Various omissions, substitutions and changes can be made without departing from the gist of the invention. The embodiments and the modifications thereof are within the scope and the gist of the invention and within the scope of the inventions described in the claims and their equivalents.

1. An electrolyte leakage detection system for a battery, comprising:
a first irradiation unit that irradiates a first surface of a battery with a first light, the first light being for determining battery data on a type of the battery;
a first acquisition unit that acquires image data obtained by taking an image of the first surface of the battery irradiated with the first light by the first irradiation unit;
a battery data determination unit that determines the battery data based on the image data acquired by the first acquisition unit;
a second irradiation unit that irradiates the first surface of the battery with a second light corresponding to the battery data determined by the battery data determination unit, the second light being for detecting an electrolyte adhered to the battery;
a second acquisition unit that acquires spectral image data obtained by taking an image of the first surface of the battery irradiated with the second light by the second irradiation unit; and
a detection unit that detects the electrolyte based on the spectral image data acquired by the second acquisition unit.

2. The electrolyte leakage detection system for a battery according to claim 1, wherein
the battery data determination unit extracts area data indicating an area in which an intensity of the first light becomes equal to or more than a threshold value from the image data acquired by the first acquisition unit, and determines the battery data based on the area data.

3. The electrolyte leakage detection system for a battery according to claim 1, wherein
the second irradiation unit includes two or more lighting devices having mutually different angles of irradiating the first surface of the battery with the second light for detecting the electrolyte adhered to the battery, selects a lighting device that emits the second light from the two or more lighting devices corresponding to the battery data determined by the battery data determination unit, and irradiates the first surface of the battery with the second light using the lighting device.

4. The electrolyte leakage detection system for a battery according to claim 1, wherein
the second irradiation unit designates a wavelength of the second light corresponding to the battery data determined by the battery data determination unit.

5. The electrolyte leakage detection system for a battery according to claim 1, wherein
the second acquisition unit acquires any of the spectral image data including the second light reflected by the first surface of the battery, the spectral image data including the second light scattered by the first surface of the battery, and the spectral image data including a light of the electrolyte fluoresced by the second light corresponding to the battery data determined by the battery data determination unit.

6. The electrolyte leakage detection system for a battery according to claim 1, wherein
the detection unit selects a specific wavelength in a predetermined wavelength range as a normalization wavelength and a specific wavelength in a predetermined wavelength range as an evaluation wavelength based on the spectral image data acquired by the second acquisition unit, calculates a reflectance from a difference of a spectral intensity between the normalization wavelength and the evaluation wavelength in a wavelength range between the normalization wavelength and the evaluation wavelength, and detects the electrolyte based on the calculated reflectance.

7. An electrolyte leakage detection method for a battery, comprising:
irradiating a first surface of a battery with a first light, the first light being for determining battery data on a type of the battery;
acquiring image data obtained by taking an image of the first surface of the battery irradiated with the first light by the irradiating of the first surface;
determining the battery data based on the image data acquired by the acquiring of the image data;
irradiating the first surface of the battery with a second light corresponding to the battery data determined by the determining of the battery data, the second light being for detecting an electrolyte adhered to the battery;
acquiring spectral image data obtained by taking an image of the first surface of the battery irradiated with the second light by the irradiating of the first surface; and
detecting the electrolyte based on the spectral image data acquired by the acquiring of the spectral image data.

8. The electrolyte leakage detection system for a battery according to claim 2, wherein
the second irradiation unit includes two or more lighting devices having mutually different angles of irradiating the first surface of the battery with the second light for detecting the electrolyte adhered to the battery, selects a lighting device that emits the second light from the two or more lighting devices corresponding to the battery data determined by the battery data determination unit, and irradiates the first surface of the battery with the second light using the lighting device.

9. The electrolyte leakage detection system for a battery according to claim 2, wherein
the second irradiation unit designates a wavelength of the second light corresponding to the battery data determined by the battery data determination unit.

10. The electrolyte leakage detection system for a battery according to claim 3, wherein
the second irradiation unit designates a wavelength of the second light corresponding to the battery data determined by the battery data determination unit.

11. The electrolyte leakage detection system for a battery according to claim 2, wherein
the second acquisition unit acquires any of the spectral image data including the second light reflected by the first surface of the battery, the spectral image data including the second light scattered by the first surface of the battery, and the spectral image data including a light of the electrolyte fluoresced by the second light corresponding to the battery data determined by the battery data determination unit.

12. The electrolyte leakage detection system for a battery according to claim 3, wherein
the second acquisition unit acquires any of the spectral image data including the second light reflected by the first surface of the battery, the spectral image data including the second light scattered by the first surface of the battery, and the spectral image data including a light of the electrolyte fluoresced by the second light corresponding to the battery data determined by the battery data determination unit.

13. The electrolyte leakage detection system for a battery according to claim 4, wherein
the second acquisition unit acquires any of the spectral image data including the second light reflected by the first surface of the battery, the spectral image data including the second light scattered by the first surface of the battery, and the spectral image data including a light of the electrolyte fluoresced by the second light corresponding to the battery data determined by the battery data determination unit.

14. The electrolyte leakage detection system for a battery according to claim 2, wherein
the detection unit selects a specific wavelength in a predetermined wavelength range as a normalization wavelength and a specific wavelength in a predetermined wavelength range as an evaluation wavelength based on the spectral image data acquired by the second acquisition unit, calculates a reflectance from a difference of a spectral intensity between the normalization wavelength and the evaluation wavelength in a wavelength range between the normalization wavelength and the evaluation wavelength, and detects the electrolyte based on the calculated reflectance.

15. The electrolyte leakage detection system for a battery according to claim 3, wherein
the detection unit selects a specific wavelength in a predetermined wavelength range as a normalization wavelength and a specific wavelength in a predetermined wavelength range as an evaluation wavelength based on the spectral image data acquired by the second acquisition unit, calculates a reflectance from a difference of a spectral intensity between the normalization wavelength and the evaluation wavelength in a wavelength range between the normalization wavelength and the evaluation wavelength, and detects the electrolyte based on the calculated reflectance.

16. The electrolyte leakage detection system for a battery according to claim 4, wherein
the detection unit selects a specific wavelength in a predetermined wavelength range as a normalization wavelength and a specific wavelength in a predetermined wavelength range as an evaluation wavelength based on the spectral image data acquired by the second acquisition unit, calculates a reflectance from a difference of a spectral intensity between the normalization wavelength and the evaluation wavelength in a wavelength range between the normalization wavelength and the evaluation wavelength, and detects the electrolyte based on the calculated reflectance.

17. The electrolyte leakage detection system for a battery according to claim 5, wherein
the detection unit selects a specific wavelength in a predetermined wavelength range as a normalization wavelength and a specific wavelength in a predetermined wavelength range as an evaluation wavelength based on the spectral image data acquired by the second acquisition unit, calculates a reflectance from a difference of a spectral intensity between the normalization wavelength and the evaluation wavelength in a wavelength range between the normalization wavelength and the evaluation wavelength, and detects the electrolyte based on the calculated reflectance.
